(19) United States
(12) Patent Application Publication
(10) Pub. No.: US 2010/0299836 A1
(43) Pub. Date: Dec. 2, 2010

(54) MATTRESS COVER FOR DISASTER TIME TRANSPORTATION

(75) Inventors: Makoto Tanaka, Tokyo (JP); Akira Nishimura, Tokyo (JP); Yumiko Mori, Tokyo (JP); Yutaka Andou, Tokyo (JP); Kouichi Kaneko, Tokyo (JP)

Correspondence Address: DARBY & DARBY P.C., P.O. BOX 770, Church Street Station, New York, NY, 10008-0770, US

(73) Assignee: PARAMOUNT BED CO., LTD., Tokyo (JP)

(21) Appl. No.: 12/160,795

(22) PCT Filed: Jul. 26, 2007
(86) PCT No.: PCT/JP2007/064706

§ 371 Date: Aug. 12, 2010

(30) Foreign Application Priority Data
Jul. 26, 2006 (JP) 2006-203233

(51) Int. Cl. A61G 1/00

(52) U.S. Cl. 5/626

(57) ABSTRACT

An ordinary bed mattress used in an ordinary situation by a person unable to take refuge by himself/herself such as a patient unable to walk or bedridden patient can be used as a component of a stretcher in a disaster situation, if the mattress is contained in the mattress cover of this invention, and the person lying on it can be carried to a safe place for evacuation.

This invention proposes a mattress cover for disaster time transportation, comprising a mattress inserting portion for inserting a mattress into the cover, grip portions attached to the cover at the portions corresponding to the corners of the mattress as contained within the cover, and the ends on one side of multiple fastening belts to be fastened across in the transverse direction of the mattress as contained within the cover, being fixed to the cover at the portions corresponding to the longitudinal edges of the mattress as contained within the cover.

### TECHNICAL FIELD

The present invention relates to a mattress cover for disaster time transportation, which allows a general mattress used mainly by an elderly person, patient or the like in a hospital, other medical facility, elderly health-care facility or the like to be used for carrying a disabled person in a disaster situation.

### BACKGROUND ART

In cases where disasters such as fires and earthquakes occur in hospitals, other medical facilities, elderly health-care facilities, etc., stretchers are often used to manually carry people who cannot take refuge by themselves such as patients unable to walk and bedridden patients, to safe places for evacuation. In such cases, if elevators stop, those people must be carried through stairways.

These evacuation activities include the work of carrying an empty stretcher from a storage place to the bedside of each disabled person, the work of transferring the disabled person from the bed to the stretcher, and the work of carrying the disabled person placed on the stretcher to a safe place. In general, 2 to 4 persons are necessary for carrying one disabled person by means of a stretcher to a safe place.

For the purpose of quickly performing such evacuation work with less manpower, for example, Patent Document 1 proposes a stretcher comprising a cushiony mattress. The stretcher of Patent Document 1 comprises a cushiony bendable mattress having cylindrical holding portions along the longitudinal edges of the mattress on both sides, with a shoulder belt inserted through each of the cylindrical holding portions; the shoulder belts extending from the respective ends of the cylindrical holding portions provided along both the longitudinal edges of the mattress are connected with each other to form loops at both the ends in the longitudinal direction; multiple fastening belts with their ends on one side fixed to both the longitudinal edges are disposed to oppose each other and lie in the transverse direction of the mattress; and buckles are fixed as fastening members to the ends on the other side of the fastening belts opposing each other.

According to Patent Document 1, the stretcher with the above constitution can be compactly stowed and can be used to efficiently and easily carry a person, and further since it is cushiony, even if the stretcher with a person on it is carried and placed on the ground, etc. to wait for any further action, the person can remain comfortable on the stretcher.

Further, as another example, Patent Document 2 describes a mattress set capable of being used as a bed mattress in an ordinary situation and capable of being used as a stretcher in an emergency/disaster situation such as an earthquake.

Furthermore, as a further other example, Patent Document 3 describes a health-care mattress that can be moved to another bed or to a bathroom, etc. with a person kept lying on the mattress.
Patent Document 1: JP6-21466Y
Patent Document 2: JP9-122177A
Patent Document 3: JP2002-102295A

### DISCLOSURE OF THE INVENTION

### Problems to be Solved by the Invention

The abovementioned stretcher of Patent Document 1 is formed by using a mattress, but the stretcher is not supposed at all to be used as a mattress on which a person lies while it is not used as a stretcher. That is, since it “can be compactly stored,” it is stored while it is not used as a stretcher.

Similarly the mattress set of Patent Document 2 can be used as a mattress bed of an emergency refugee in a gymnastic hall, etc. or as a stretcher when a disaster such as an earthquake occurs, and usually it is stored in a folded state.

If any of these mattresses, etc. should be used as an ordinary bed mattress while it is not used as a stretcher, the shoulder belts, fastening belts and others exposed outside the mattress may disturb the patient, elderly person or the like using the mattress when he/she leaves from the bed, since he/she may be caught by the belts and fall down. Further, in the case where the bed is an electric bed, when the bed bottom is raised, lowered or tilted, the belts may be caught in a mechanical member, to prevent the bed movement or to damage the mattress inconveniently. After all, the stretcher cannot be used as an ordinary bed mattress.

Further, the health-care mattress of Patent Document 3 is a special mattress that can be used to move a person lying on the mattress to another bed or to carry him/her to a bathroom, etc. or, as required, to allow a patient or the like lying on the mattress to be bathed. So, the health-care mattress cannot be used as an ordinary bed mattress.

The present invention has been created in view of the above situations. The object of this invention is to allow a usually used mattress to be used for carrying a patient or the like in a disaster situation.

### Means for Solving the Problems

To solve the abovementioned problems, this invention proposes a mattress cover for disaster time transportation, comprising a mattress inserting portion for inserting a mattress into the cover, grip portions attached to the cover at the portions corresponding to the corners of the mattress as contained within the cover, and the ends on one side of multiple fastening belts to be fastened across in the transverse direction of the mattress as contained within the cover, being fixed to the cover at the portions corresponding to the longitudinal edges of the mattress as contained within the cover.

Further, this invention proposes a mattress cover for disaster time transportation, comprising a mattress inserting portion for inserting a mattress into the cover, grip portions attached to the cover at the portions corresponding to the corners of the mattress as contained within the cover, and the ends on one side of multiple fastening belts to be fastened across in the transverse direction of the mattress as contained within the cover, being detachably fixed to the cover at the portions corresponding to the longitudinal edges of the mattress as contained within the cover.

Further, this invention proposes the above constitution, wherein a pocket extending in the transverse direction is formed on the front surface side of the cover at the portion corresponding to an end portion in the longitudinal direction of the mattress as contained within the cover. This invention also proposes that the pocket is formed by a cloth piece sewn to the front surface side of the cover at longitudinal edge portions and a bottom edge portion.

Further, this invention proposes the above constitution, wherein stowing portions for stowing the fastening belts are formed in the cover at the portions corresponding to the longitudinal edges of the mattress as contained within the cover. This invention also proposes that the stowing portions can be opened and closed.

Further, this invention proposes the above constitution, wherein the fastening belts provided in pairs are provided with corresponding fastening members at their tips. This invention also proposes that each pair of the fastening members is a buckle consisting of a male part and a female part.

Further, this invention proposes the above constitution, wherein a friction reducing member(s) is/are attached to the rear surface of the cover.

Further, this invention proposes the above constitution, wherein each of the grip portions is a looped belt.

Further, this invention proposes the above constitution, wherein the mattress inserting portion is an opening that is formed in the cover at the portion corresponding to a transverse edge of the mattress as contained within the cover and can be opened and closed by means of a fastener.

Further, this invention proposes that the mattress inserting portion is an opening formed on the front surface side of the cover as an open joint formed in the longitudinal direction or in the transverse direction between the mating sheets constituting the front surface side.

Further, this invention proposes that the mattress inserting portion is an extensible opening that is formed on the front surface side of the cover and can be shrunken by the elasticity of a rubber material attached to the periphery of the opening.

### Effects of the Invention

The mattress cover for disaster time transportation of this invention, can be used in the following manner. In the case where a disaster such as a fire or earthquake occurs in a hospital, other medical facility, elderly health-care facility or the like, the mattress used by a patient or the like is inserted into the mattress cover from the mattress inserting portion, to be contained within the cover. Then, a disabled person to be carried such as a patient is made to lie on the mattress cover containing the mattress, and the fastening belts are fastened across in the transverse direction of the mattress, to support the disabled person on the mattress. In this state, a nurse or the like can hold the grip portions of the mattress cover, to move the mattress, for safely carrying the patient or the like supported on the mattress to a safe place.

In the case where sufficient manpower is available, the mattress contained within the mattress cover can of course be moved by multiple persons, but if the manpower is insufficient, one nurse or the like can hold appropriate grip portions, for examples, the grip portions near the head of the disabled person supported on the mattress, to drag and move the mattress.

When the mattress is carried as described above, the disabled person is positioned on the padding of the mattress. Therefore, even if there is an obstacle such as a level difference on the floor when the mattress is dragged and moved, the impact by the obstacle can be absorbed by the padding without displeasing the disabled person.

In this case, if the cover has a pocket extending in the transverse direction on the front surface side at the portion corresponding to an edge portion in the longitudinal direction of the mattress, the legs of the disabled person can be inserted into the pocket, and if he/she is carried in this state, it can be prevented that he/she slips down.

Further, in this invention, in an ordinary situation where it is not required to use the mattress cover, the cover can be stored in any proper place with a small space, and the mattress, which is an ordinary bed mattress, can be used as usual without any problem.

In the above constitution, the fastening belts can be fixed to the mattress cover at their ends on one side, and in this case, if fastening belt stowing portions are formed in the cover at the portions corresponding to the longitudinal edges of the mattress as contained within the cover, the fastening belts can be stowed in the stowing portions without being obtrusive when the mattress cover is not used. If the stowing portions can be opened and closed, it can be prevented that the stowed fastening belts drop.

Further, the fastening belts can also be detachably fixed to the mattress cover at their ends on one side. In this case, the mattress cover can be simplified in its folded style, to allow rational storing.

If the fastening belts provided in pairs are provided with corresponding fastening members such as buckles at their tips, they can be easily fastened across in the transverse direction of the mattress.

Further, if a friction reducing member(s) is/are attached to the rear surface of the mattress cover, the friction resistance acting when the mattress is dragged and moved can be reduced, allowing the mattress to be carried with less labor force.

If each of the grip portions is a looped belt, the wrists can be inserted into the looped belts, for gripping them, or the looped belts can also be merely gripped. The looped belts are easy to grip and allow larger forces to be applied, without being obtrusive.

In this invention, the mattress inserting portion used for inserting the mattress into the mattress cover, to keep the mattress contained within the mattress cover can be an opening that is formed in the cover at the portion corresponding to a transverse edge of the mattress as contained within the cover and can be opened and closed by means of a fastener, or an opening that is formed on the front surface side of the cover as an open joint formed in the longitudinal direction or transverse direction between the mating sheets constituting the front surface side, or an extensible opening that is formed on the front surface side of the cover and can be shrunken by the elasticity of a rubber material attached to the periphery of the opening.

### BRIEF DESCRIPTION OF THE DRAWINGS

FIG. 1 is a perspective view showing the appearance of a first embodiment representing the mattress cover of this invention.

FIG. 2 is a perspective view showing the appearance of the mattress to be contained within the mattress cover of FIG. 1.

FIG. 3 is a perspective view showing a state where a mattress is being inserted into a mattress cover.

FIG. 4 is a partially cutaway perspective view showing a state where a mattress is being contained within a mattress cover.

FIG. 5 is an expanded view showing the cutaway portion of FIG. 4.

FIG. 6 is a side view showing a fastening belt stowing portion.

FIG. 7 is a perspective view showing a state where fastening belts are being fastened across in the transverse direction of the mattress.

FIG. 8 is a perspective view showing a state where a disabled person is being carried using the mattress cover of this invention.

FIG. 9 is a perspective view showing the appearance of a second embodiment representing the mattress cover of this invention.

FIG. 10 is a perspective view showing a state where a mattress is being inserted into the mattress cover of the second embodiment of this invention.

FIG. 11 is a perspective view showing the appearance of a third embodiment representing the mattress cover of this invention.

FIG. 12 is a bottom view showing an important portion of the mattress cover of this invention with friction reducing members.

FIG. 13 is a side view showing a friction reducing member used for the mattress cover of this invention.

### MEANING OF SYMBOLS

1 mattress cover for carrying a disabled person in a disaster situation
2 mattress inserting portion
3 mattress
4 fastener
5 grip portion
6a, 6b fastening belt
7a, 7b stowing portion
8 fastener
9a fastening member (male part)
9b fastening member (female part)
10 pocket
11 handle
12 disabled person (patient or the like)
13 nurse or the like
14 open joint between mating sheets
15 friction reducing member
16 sphere support
17 sphere

### THE BEST MODES FOR CARRYING OUT THE INVENTION

Embodiments of this invention are explained below in reference to the drawings.

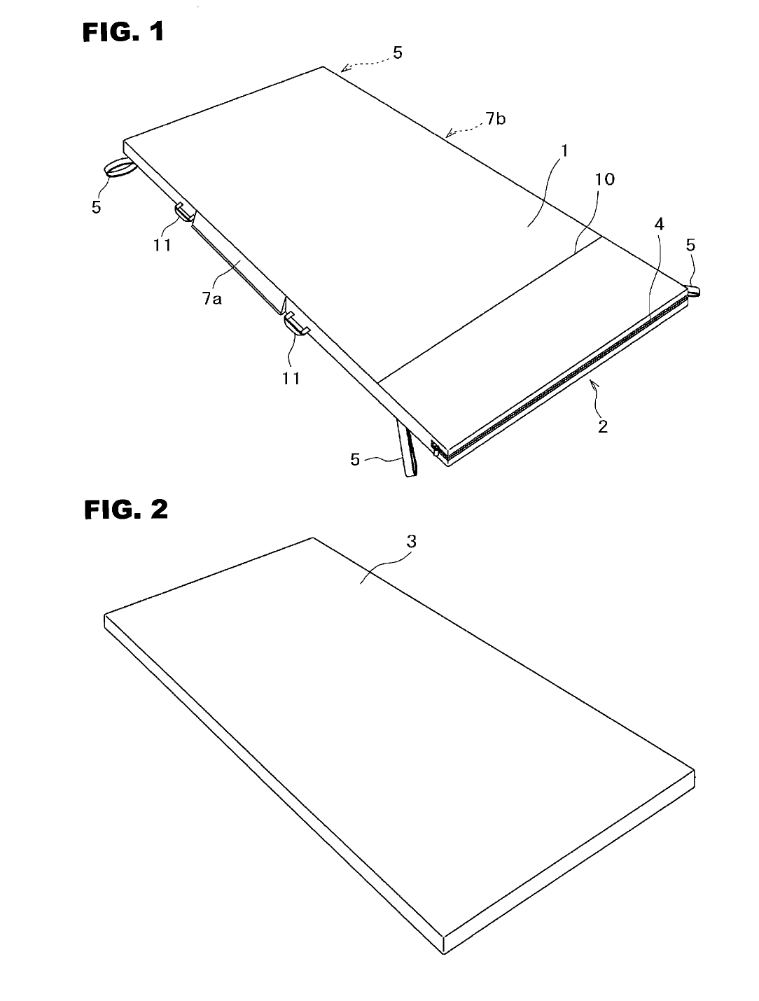

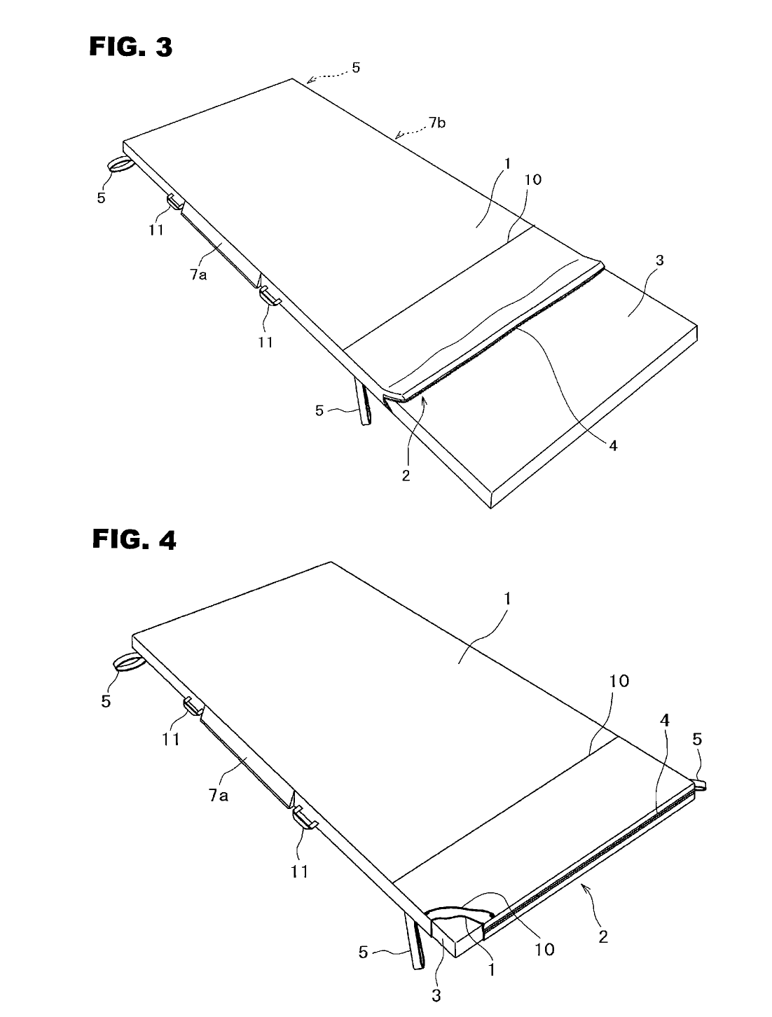

First of all, FIGS. 1 through 8 are illustrations showing the constitution and action of the first embodiment representing the mattress cover of this invention.

In the drawings, symbol 1 denotes the mattress cover of this invention, used for carrying a disabled person in a disaster situation. The mattress cover 1 is a flat rectangular parallelepiped bag made from a cloth or sheet material and is designed to contain a mattress 3 inserted from a mattress inserting portion 2.

In this embodiment, the mattress inserting portion 2 is formed in the cover at the portion corresponding to a transverse edge of the mattress as contained within the cover and can be opened and closed by means of a fastener 4.

Grip portions 5 are attached to the mattress cover 1 at the portions corresponding to the four corners of the mattress 3 as contained within the cover, and in this embodiment, the grip portions 5 are formed as looped belts. In FIGS. 1, 3 and 4, the grip portions 5 on the depth side are hidden behind the main part of the cover and indicated by symbol 5 only.

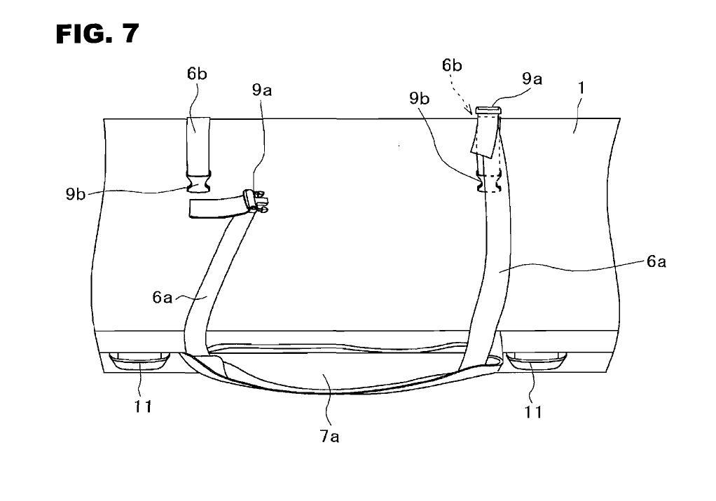

Further, as shown in FIG. 7, the mattress cover 1 has multiple pairs of fastening belts, particularly two pairs of fastening belts 6a and 6b attached with a distance kept between them in the longitudinal direction and with their ends on one side fixed at the portions corresponding to two portions each of both the longitudinal edges of the mattress 3 as contained within the cover. Furthermore, openable and closable stowing portions 7a and 7b for stowing the two pairs of fastening belts 6a and 6b are provided. Each of the stowing portions 7a and 7b can be opened and closed by a fastener 8 such as a slide fastener, or a plane fastener such as a loop-hook fastener, or any other fastener such as a hook-and-eye fastener. Meanwhile, in the drawings, the parts of one of the longitudinal edges are indicated by subscript a, and the parts of the other longitudinal edge are indicated by subscript b. Further, the fastening belts 6b and the stowing portion 7b on the depth side hidden behind the main part of the cover are denoted by symbols only.

Further, fastening members 9a and 9b are fixed at the ends on the other side of the respective fastening belts 6a and 6b, so that the respective fastening belts 6a and 6b provided as pairs in opposite to each other in the transverse direction of the mattress 1 can be connected with each other by the fastening members 9a and 9b. In this embodiment, either the fastening belts 6a or 6b (particularly the fastening belts 6a in this case) can be adjusted in the length up to the fastening members 9a.

In this embodiment, a pair consisting of a fastening member 9a and a fastening member 9b is a buckle consisting of a male part 9a and a female part 9b to achieve fastening by the resilient engagement between the engagement pieces of the male and female parts. On the male part 9a side, the fastening belt 6a can be adjusted in length as described above. Since the constitution of the buckle and the length adjustment are obvious, their further explanation is not made here.

Meanwhile, the length of the fastening belt 6a for the male part 9a can be set at an appropriate length beforehand. So, the male part 9a can also be fixed at the other end of the fastening belt 6a with a predetermined length like the female part 9b, so that the length cannot be adjusted. That is, on the side of either the male part 9a or the female part 9b, the fastening belt 6a or 6b can be adjusted in length, or it is possible that neither the fastening belt 6a nor the fastening belt 6b can be adjusted in length.

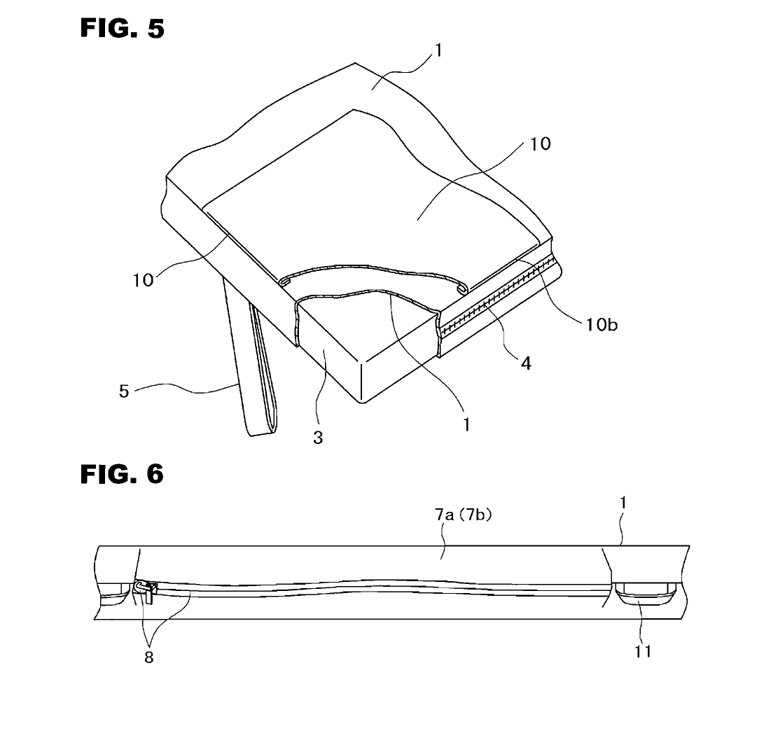

Furthermore, the mattress cover 1 has a pocket 10 extending in the transverse direction, formed on the front surface side of the cover at the portion corresponding to an edge in the longitudinal direction of the mattress 3 as contained within the cover. In this embodiment, the pocket 10 is formed by sewing a cloth piece at the longitudinal edge portions 10a and the bottom edge portion 10b as shown in FIGS. 4 and 5.

Meanwhile in the drawings, each symbol 11 denotes a handle as attached to an ordinary bed mattress, to allow carrying. The handles 11 can be used to carry the mattress 3 contained within the mattress cover 1.

In the above constitution, in the case where a disaster such as a fire or earthquake occurs in a hospital, other medical facility, elderly health-care facility or the like, the mattress 3 used by a disabled person 12 such as a patient is inserted into the mattress cover 1 from the mattress inserting portion 2, to be contained within the mattress cover. Then, the disabled person 12 is made to lie on the mattress cover 1 containing the mattress 3, and his/her legs are inserted into the pocket 10, while the fastening belts 6a and 6b are fastened with each other in the transverse direction of the mattress 3, to support the disabled person on the mattress 3.

In this state, if a nurse or the like holds the grip portions 5 of the mattress cover 1, for moving the mattress 3, the disabled person 12 such as a patient supported on the mattress 3 can be safely carried to a safe place.

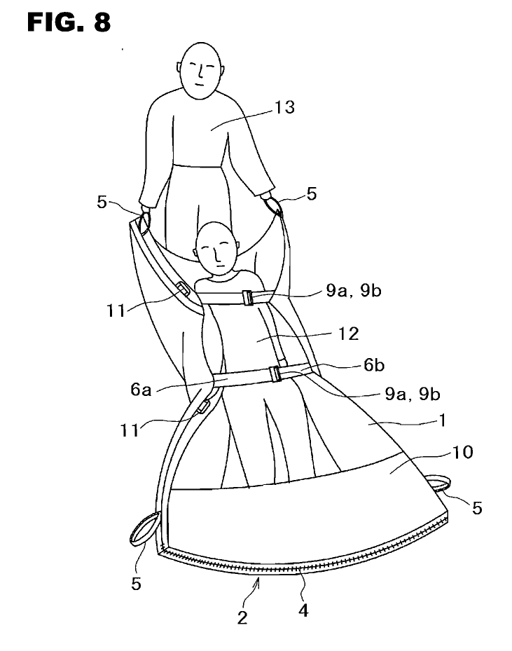

If there is sufficient manpower, the mattress 3 contained in the mattress cover 1 can of course be carried by multiple persons, but if the manpower is insufficient, one nurse or the like 13 can hold appropriate grip portions of the mattress, for example, the two grip portions 5 on the head side of the disabled person 12 supported on the mattress, to drag and move the mattress 3 contained within the mattress cover 1, as shown in FIG. 8.

When the disabled person 12 is carried as described above, he/she is positioned on the padding of the mattress 3. Therefore, even if there is an obstacle such as a level difference on the floor when the mattress is dragged and moved, the impact can be absorbed by the padding without displeasing the disabled person 12.

During the carrying, since the disabled person 12 is supported by the fastening belts 6a and 6b and has his/her legs kept inserted in the pocket 10, it can be prevented that he/she slides down.

In this invention, in an ordinary situation where it is not necessary to use the mattress cover, it is merely required to store the mattress cover 1 only in an appropriate place with a small storing space. Further, since the mattress 3 is an ordinary bed mattress, it can be used as usual without any problem.

In the above constitution, the fastening belts 6a and 6b can be fixed to the mattress cover 1 at their ends on one side, and in this case, since the stowing portions 7a and 7b are formed at the portions corresponding to the longitudinal edges of the mattress as contained within the cover, the fastening belts 6a and 6b can be stowed in the stowing portions 7a and 7b without being obtrusive, when the mattress cover is not used.

In addition, the fastening belts 6a and 6b can also be detachably fixed to the same portions of the mattress cover 1 at their ends on one side, and in this case, since the mattress cover 1 detached from the fastening belts 6a and 6b can be folded, the storing style can be simplified to allow rational storing.

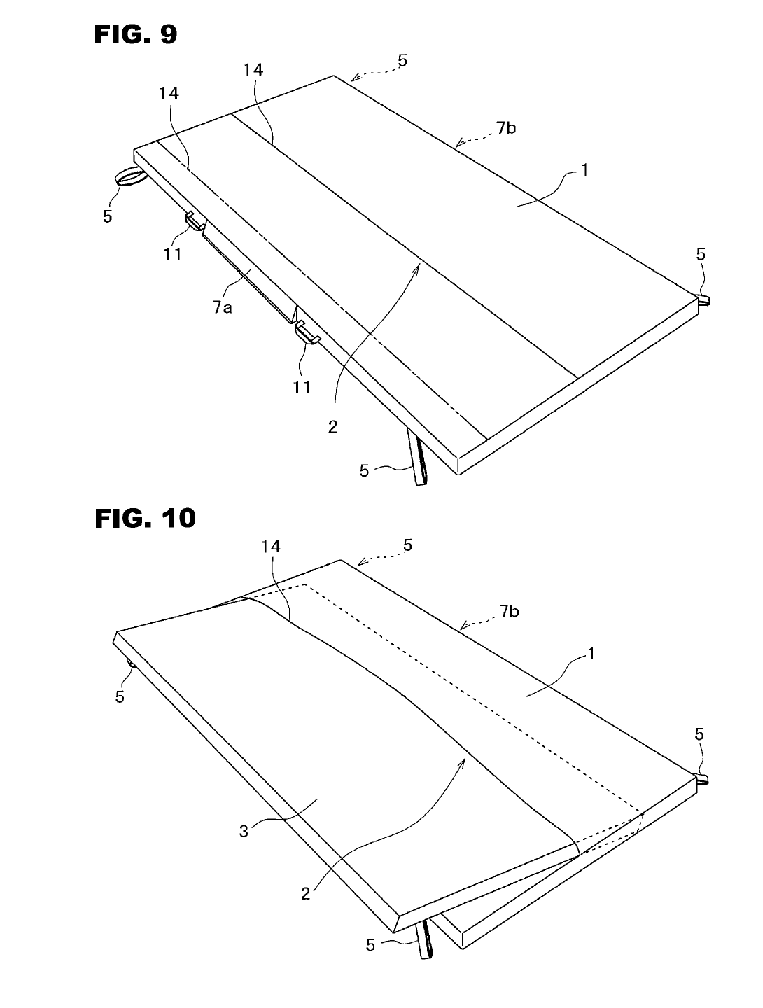

FIG. 9 is a perspective view showing the appearance of a second embodiment representing the mattress cover of this invention, and FIG. 10 is a perspective view showing a state where a mattress is being inserted into the mattress cover.

In this embodiment, the mattress inserting portion 2 is an opening provided on the front surface side of the mattress cover 1 as an open joint 14 formed in the longitudinal direction (or transverse direction) between the mating sheets constituting the front surface side. Since the other components are the same as those of the first embodiment, those components are denoted by the same symbols to avoid double explanation.

In the above constitution, as shown in FIG. 10, the open joint 14 indicated by a solid line in FIG. 9 formed between the mating sheets can be opened to insert the mattress 3 into the mattress cover 1. In order that the mattress 3 as a whole can be inserted into the mattress cover 1 from the open joint 14 formed between the mating sheets, the mattress cover is designed such that one of the mating sheets constituting the front surface side of the mattress cover 1 and separated at the open joint 14 can be turned outward for opening and turned back inward for closing. At first, the mattress 3 is inserted under the other mating sheet from the open joint 14, and with said one mating sheet kept turned outward for opening, the mattress 3 as a whole is fitted in the mattress cover, being partially covered by the other mating sheet. Then, the mating sheet kept turned outward is turned back inward to complementarily cover the mattress 3. In this state, both the mating sheets are joined by means of a fastener such as a plane fastener (not shown in the drawing), to finally keep the mattress contained within the mattress cover.

As a modified embodiment, if the open joint 14 between the mating sheets is near an edge as indicated by a two-dot-dash-line in FIG. 9 on the front surface side of the mattress cover 1, it is not necessary that one of the mating sheets can be turned outward for opening and turned back inward for closing.

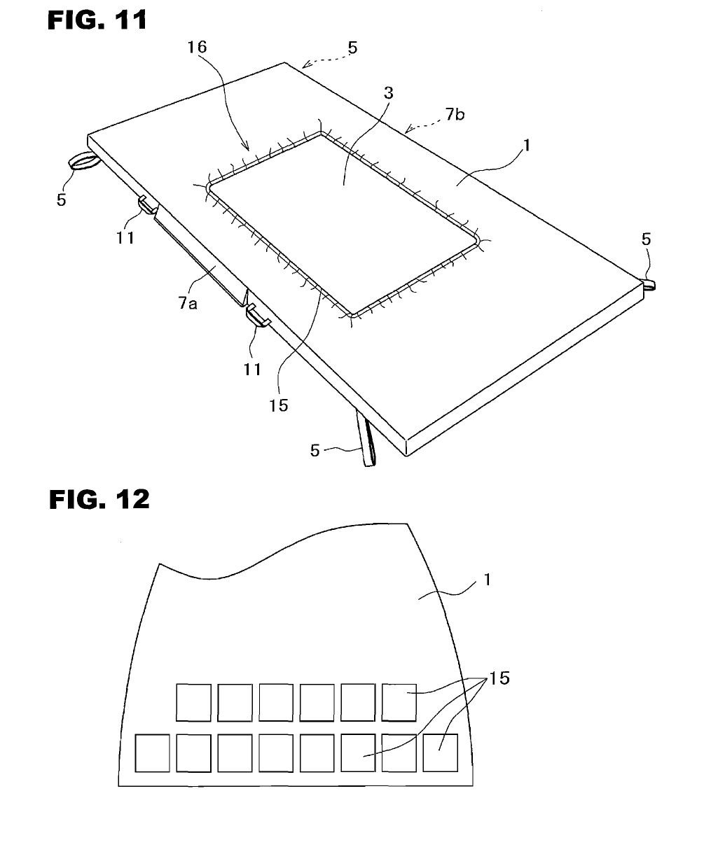

FIG. 11 is a perspective view showing the appearance of a third embodiment representing the mattress cover of this invention. In this embodiment, the mattress inserting portion 2 is formed on the front surface side of the mattress cover 1, and the opening as the mattress inserting portion 2 can be shrunken by the elasticity of a rubber material 15 attached to the periphery of the opening. Since the other components are the same as those of the first embodiment, the corresponding components are given the same symbols to avoid double explanation.

In this constitution, the opening is expanded against the elasticity of the rubber material 15, and in this state, the mattress 3 can be inserted into the mattress cover 1 all at once.

Meanwhile, though FIGS. 9 through 11 do not show the pocket 10, the pocket 10 can be formed in any appropriate manner also in these second and third embodiments. Further in this invention including these embodiments, the pocket 10 of the mattress cover 1 can also be detachably formed using any appropriate fastening means such as a fastener.

FIG. 12 is an expanded view showing an important portion of a fourth embodiment representing the mattress cover of this invention. This drawing shows the rear surface side of the mattress cover 1, which contacts the floor surface when the mattress cover 1 is dragged.

In this embodiment, the mattress cover 1 has flat friction reducing members 15 attached to the rear surface side near an edge, and each of the friction reducing members 15 has a sliding surface of fluorine resin, etc.

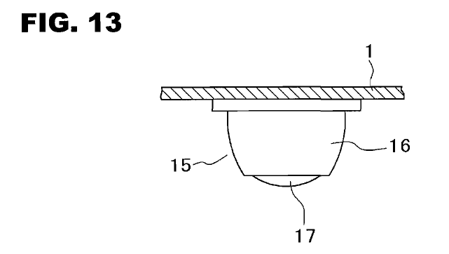

FIG. 13 is an expanded view showing an important portion of a fifth embodiment representing the mattress cover of this invention. This drawing is a sectional view showing the rear surface side of the mattress cover 1, which contacts the floor surface when the mattress cover 1 is dragged.

In this embodiment, a wheel in which a sphere 17 is rotatably supported by a sphere support 16 is installed as a friction reducing member 15 near an edge on the rear surface side of the mattress cover 1.

If a friction reducing member(s) 15 is/are installed on the rear surface of the mattress cover 1 as in these fourth and fifth embodiments, the friction resistance acting when the mattress cover is dragged and moved can be reduced to allow the disabled person to be carried with less labor force.

### INDUSTRIAL APPLICABILITY

Since this invention is as described above, an ordinary bed mattress used in an ordinary situation by a person unable to take refuge by himself/herself such as a patient unable to walk or bedridden patient can be used as a component of a stretcher in a disaster situation, if the mattress is contained in the mattress cover of this invention, and the person lying on it can be carried to a safe place for evacuation.

Further, in this invention, even one nurse or the like can use the ordinary bed mattress contained within the mattress cover of this invention safely as a stretcher in a disaster situation, and the cushiony padding of the ordinary bed mattress can absorb and ease the impact caused when the mattress is dragged and moved, without displeasing the patient or the like.

1. A mattress cover for disaster time transportation, comprising:
a mattress inserting portion for inserting a mattress into the cover,
grip portions attached to the cover at the portions corresponding to the corners of the mattress as contained within the cover, and
ends on one side of multiple fastening belts to be fastened across in the transverse direction of the mattress as contained within the cover, being fixed to the cover at the portions corresponding to longitudinal edges of the mattress as contained within the cover.

2. A mattress cover for disaster time transportation, comprising:
a mattress inserting portion for inserting a mattress into the cover,
grip portions attached to the cover at the portions corresponding to the corners of the mattress as contained within the cover, and
ends on one side of multiple fastening belts to be fastened across in the transverse direction of the mattress as contained within the cover, being detachably fixed to the cover at the portions corresponding to the longitudinal edges of the mattress as contained within the cover.

3. The mattress cover for disaster time transportation, according to claim 1, a pocket extending in the transverse direction is formed on the front surface side of the cover at the portion corresponding to an end portion in the longitudinal direction of the mattress as contained within the cover.

4. The mattress cover for disaster time transportation, according to claim 3, wherein the pocket is formed by a cloth piece sewn to the front surface side of the cover at longitudinal edge portions and a bottom edge portion.

5. The mattress cover for disaster time transportation, according to claim 1, wherein stowing portions for stowing the fastening belts are formed in the cover at the portions corresponding to the longitudinal edges of the mattress as contained within the cover.

6. The mattress cover for disaster time transportation, according to claim 5, wherein the stowing portions can be opened and closed.

7. The mattress cover for disaster time transportation, according to claim 1, wherein the fastening belts provided in pairs are provided with corresponding fastening members at their tips.

8. The mattress cover for disaster time transportation, according to claim 7, wherein each pair of the fastening members is a buckle consisting of a male part and a female part.

9. The mattress cover for disaster time transportation, according to claim 1, wherein a friction reducing member(s) is/are attached to the rear surface of the cover.

10. The mattress cover for disaster time transportation, according to claim 1, wherein each of the grip portions is a looped belt.

11. The mattress cover for disaster time transportation, according to claim 1, wherein the mattress inserting portion is an opening that is formed in the cover at the portion corresponding to a transverse edge of the mattress as contained within the cover and can be opened and closed by means of a fastener.

12. The mattress cover for disaster time transportation, according to claim 1, wherein the mattress inserting portion is an opening formed on the front surface side of the cover as an open joint formed in the longitudinal direction or in the transverse direction between the mating sheets constituting the front surface side.

13. The mattress cover for disaster time transportation, according to claim 1, wherein the mattress inserting portion is an extensible opening that is formed on the front surface side of the cover and can be shrunken by the elasticity of a rubber material attached to the periphery of the opening.

14. The mattress cover for disaster time transportation, according to claim 2, wherein a pocket extending in the transverse direction is formed on the front surface side of the cover at the portion corresponding to an end portion in the longitudinal direction of the mattress as contained within the cover.

15. The mattress cover for disaster time transportation, according to claim 14, wherein the pocket is formed by a cloth piece sewn to the front surface side of the cover at longitudinal edge portions and a bottom edge portion.

16. The mattress cover for disaster time transportation, according to claim 2, wherein stowing portions for stowing the fastening belts are formed in the cover at the portions corresponding to the longitudinal edges of the mattress as contained within the cover.

17. The mattress cover for disaster time transportation, according to claim 16, wherein the stowing portions can be opened and closed.

18. The mattress cover for disaster time transportation, according to claim 2, wherein the fastening belts provided in pairs are provided with corresponding fastening members at their tips.

19. The mattress cover for disaster time transportation, according to claim 18, wherein each pair of the fastening members is a buckle consisting of a male part and a female part.

20. The mattress cover for disaster time transportation, according to claim 2, wherein a friction reducing member(s) is/are attached to the rear surface of the cover.

21. The mattress cover for disaster time transportation, according to claim 2, wherein each of the grip portions is a looped belt.

22. The mattress cover for disaster time transportation, according to claim 2, wherein the mattress inserting portion is an opening that is formed in the cover at the portion corresponding to a transverse edge of the mattress as contained within the cover and can be opened and closed by means of a fastener.

23. The mattress cover for disaster time transportation, according to claim 2, wherein the mattress inserting portion is an opening formed on the front surface side of the cover as an open joint formed in the longitudinal direction or in the transverse direction between the mating sheets constituting the front surface side.

24. The mattress cover for disaster time transportation, according to claim 2, wherein the mattress inserting portion is an extensible opening that is formed on the front surface side of the cover and can be shrunken by the elasticity of a rubber material attached to the periphery of the opening.
